(19) United States
(12) Patent Application Publication
(10) Pub. No.: US 2013/0243590 A1
(43) Pub. Date: Sep. 19, 2013

(54) SYSTEMS AND METHODS FOR DETERMINING THRUST ON A WIND TURBINE

(71) Applicant: Thomas Edenfeld, Osnabruck (DE)

(72) Inventor: Thomas Edenfeld, Osnabruck (DE)

(73) Assignee: General Electric Company

(21) Appl. No.: 13/420,872

(22) Filed: Mar. 15, 2012

(51) Int. Cl. F03D 7/00

(52) U.S. Cl. 416/1; 416/61

(57) ABSTRACT

Systems and methods for determining thrust on a wind turbine are disclosed. In one aspect, a system is described that can be comprised of a wind turbine comprising a rotor, wherein one or more rotor blades of the wind turbine are affixed to the rotor; and one or more sensors located on or within the rotor, wherein the one or more sensors measure deflection of the rotor. In one aspect, the measured deflection is correlated with thrust on the wind turbine and the measured thrust can be used to determine at least in part a pitch angle for at least one of the one or more rotor blades during peak shaving.

### FIELD OF THE INVENTION

The present subject matter relates generally to wind turbines and, more particularly, to a system and methods for determining the thrust on wind turbine rotor blades. This information can be used during peak shaving in order to reduce loads while minimizing power losses.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades are the primary elements for converting wind energy into electrical energy. The blades typically have the cross-sectional profile of an airfoil such that, during operation, air flows over the blade producing a pressure difference between the sides. Consequently, a lift force, which is directed from the pressure side towards the suction side, acts on the blade. The lift force generates torque on the main rotor shaft, which is geared to a generator for producing electricity.

At wind speeds below the rated wind speed of a wind turbine (i.e., the wind speed at which a wind turbine can achieve its rated power), the pitch angle of the rotor blades is typically maintained at the power position in order to capture the maximum amount of energy from the wind. However, as wind speeds reach and exceed the rated wind speed, the pitch angle must be adjusted towards feather to maintain the power output of the wind turbine at its rated power, thereby preventing components of the turbine, such as electrical components, from being damaged. Thus, the aerodynamic loads acting on the rotor blades continually increase with increasing wind speeds while the pitch angle of the rotor blades is maintained at the power position (i.e., until the rated wind speed is achieved) and then begin to decrease as the pitch angle is adjusted towards feather with wind speeds above the rated wind speed. Such control of the wind turbine typically creates a peak in the aerodynamic loading on a wind turbine at its rated wind speed. For example, FIG. 1 illustrates a graph of wind speed (x-axis) versus loads (y-axis) for a typical wind turbine. As shown, aerodynamic loads on the wind turbine increase to a peak 10 at the rated wind speed (indicated by line 12) and then decrease as the rotor blades are pitched toward feather in order to maintain the wind turbine at its rated power.

To prevent the formation of such a peak 10, peak shaving control methods are known that may be used to reduce the loads on a wind turbine at or near the rated wind speed. In particular, these control methods typically begin to adjust the pitch angle of the rotor blades at some point prior to the rated wind speed. For example, as shown in FIG. 1, by adjusting the pitch angle of the rotor blades towards feather prior to reaching the rated wind speed (line 12), the loads acting on the rotor blade at or near the rated wind speed may be reduced. Specifically, as shown in FIG. 1, the use of a peak shaving control method may create a peak shaving range 14 within the graph at which loads are reduced along a range of wind speed values. In part, the point to begin peak shaving is determined by thrust exerted on the rotor blades of the wind turbine by the wind. Thrust is not a measured value but can be calculated based on variables and constants such as wind speed, the design of the wind turbine, the configuration of the wind turbine (e.g., blade pitch), and the like.

While peak shaving control methods are useful for reducing the loads at or near the rated wind speed, they also result in significant power losses within the peak shaving range 14. Specifically, the rate of change in which the loads acting on a wind turbine are adjusted within the peak shaving region 14 is relatively slow, which is characterized in graph by the rounded-off, curved section 16 within the peak shaving range 14). This slow rate of change results in significant power losses, as it takes longer for the wind turbine to achieve its rated power as the pitch angle is adjusted during peak shaving.

Accordingly, an improved system and/or method that provides for sufficient load reduction while minimizing power losses based on measured thrust values would be welcomed in the technology.

### BRIEF DESCRIPTION OF THE INVENTION

Aspects and advantages of embodiments of the invention will be set forth in part in the following description, or may be obvious from the description, or may be learned through practice of the invention.

In one aspect, the present subject matter discloses a method for determining thrust on a wind turbine. The method may generally include determining an amount of deflection of a rotor of a wind turbine having one or more rotor blades affixed to the rotor; correlating the amount of deflection of the rotor with thrust on at least one of the one or more rotor blades; and adjusting a pitch angle for at least one of the one or more rotor blades during peak shaving.

In another aspect, the present subject matter discloses a system for determining thrust on a wind turbine. The system may be comprised of a wind turbine comprising a rotor, wherein one or more rotor blades of the wind turbine are affixed to the rotor; and one or more sensors located on or within the rotor, wherein the one or more sensors measure deflection of the rotor.

In another aspect, the present subject matter discloses yet another system for determining thrust on a wind turbine. The system may be comprised of a wind turbine comprising a hub, wherein one or more rotor blades of the wind turbine are affixed to the hub; one or more sensors located within the hub, wherein the one or more sensors measure deflection of the hub; and a controller, wherein the controller is configured to: receive a signal from said one or more sensors, said signal indicating an amount of deflection of the hub caused by thrust on the one or more rotor blades of the wind turbine; determine a value for the thrust on the one or more rotor blades of the wind turbine using said signal; and determine, using at least in part the value for the thrust on the one or more rotor blades of the wind turbine, a pitch angle for at least one of the one or more rotor blades during peak shaving.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates one embodiment of a graph of wind speed (x-axis) versus loads (y-axis) for a typical wind turbine, particularly illustrating the use of a conventional linear peak shaving method to reduce loads on the wind turbine;

FIG. 2 illustrates a perspective view of one embodiment of a wind turbine;

FIG. 3 illustrates a perspective, internal view of one embodiment of a nacelle of a wind turbine;

FIGS. 4A through 4C illustrate a portion of the rotor of a wind turbine having various sensors located within the hub to measure deflection of the hub caused by thrust on the one or more rotor blades of the wind turbine;

FIG. 5 illustrates a schematic diagram of one embodiment of a turbine controller of a wind turbine;

FIG. 6 illustrates a flow diagram of one embodiment of a method for determining the thrust on a wind turbine having one or more rotor blades affixed to a hub of the wind turbine by measuring deflection of the hub caused by the thrust; and

FIG. 7 illustrates a flow diagram of another embodiment of a method for determining the thrust on a wind turbine having one or more rotor blades affixed to a hub of the wind turbine by measuring deflection of the hub caused by the thrust.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and methods for determining deflection of the hub of a wind turbine having one or more rotor blades attached to the hub by one or more sensors located within the hub and using the deflection to determine thrust on the one or more rotor blades of the wind turbine. In one aspect, the measured thrust value can be used at least in part to determine a pitch angle for at least one of the one or more rotor blades of the wind turbine in order to perform peak shaving.

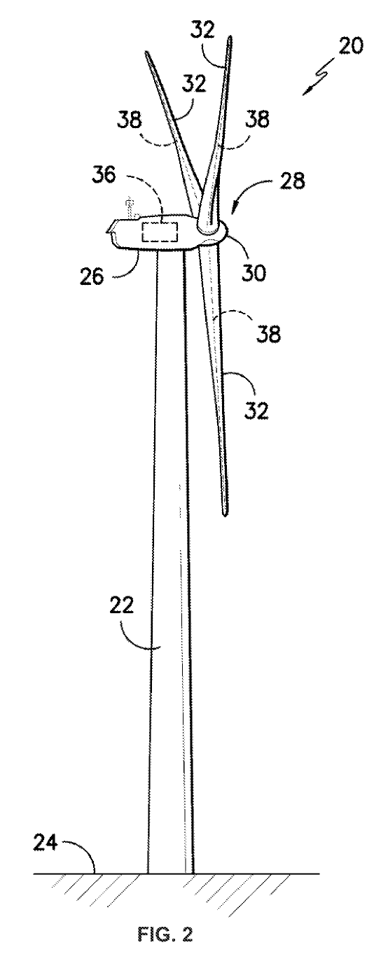

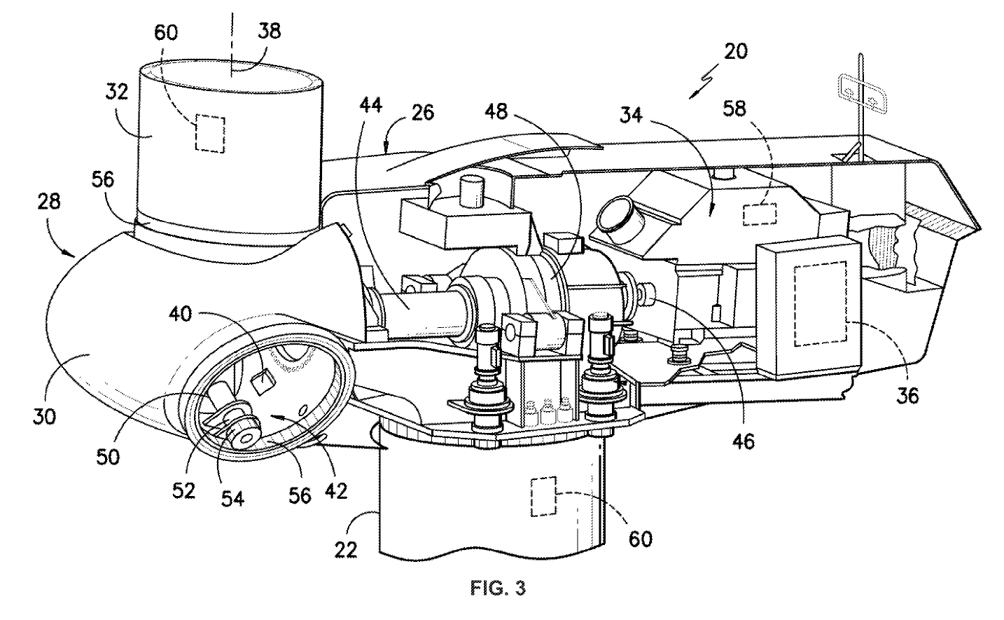

Referring now to FIG. 2, a perspective view of one embodiment of a wind turbine 20 is illustrated. As shown, the wind turbine 20 generally includes a tower 22 extending from a support surface 24, a nacelle 26 mounted on the tower 22, a rotor 28 coupled to the nacelle 26, and at least one rotor blade 32 coupled to and extending outwardly from the hub 30. For example, in the illustrated embodiment, three rotor blades 32 are coupled to the hub 30. However, alternative embodiments may include more or less than three rotor blades 32. Each rotor blade 32 may be spaced about the hub 30 to facilitate rotating the rotor 28 to enable kinetic energy to be transferred from the wind into usable mechanical energy, and subsequently, electrical energy. For instance, the hub 30 may be rotatably coupled to an electric generator 34 (FIG. 3) positioned within the nacelle 26 to permit electrical energy to be produced. The rotor 28 can include the hub 30, attachment means for affixing the one or more rotor blades 32 to the hub 30 including flanges, bolts, clamps, and the like, pitch adjustment mechanism 42 (FIG. 3), and any means for coupling the hub 30 with the electric generator 34.

The wind turbine 10 may also include a turbine control system or turbine controller 36 within the nacelle 26, or at any other suitable location. In general, the turbine controller 36 may comprise a computer or other suitable processing unit. Thus, in several embodiments, the turbine controller 36 may include suitable computer-readable instructions that, when implemented, configure the controller 36 to perform various different functions, such as receiving, transmitting and/or executing wind turbine control signals. As such, the turbine controller 36 may generally be configured to control the various operating modes (e.g., start-up or shut-down sequences) and/or components of the wind turbine 20. For example, the controller 36 may be configured to adjust the blade pitch or pitch angle of each rotor blade 22 (i.e., an angle that determines a perspective of the blade 22 with respect to the direction of the wind) about its pitch axis 38 in order to control the rotational speed of the rotor blade 32 and/or the power output generated by the wind turbine 20. For instance, the turbine controller 36 may control the pitch angle of the rotor blades 32, either individually or simultaneously, by transmitting suitable control signals directly or indirectly (e.g., via a pitch controller 40 (FIG. 3)) to one or more pitch adjustment mechanisms 42 (FIG. 3) of the wind turbine 10. During operation of the wind turbine 20, the controller 36 may generally control each pitch adjust mechanism 42 in order to alter the pitch angle of each rotor blade 30 between 0 degrees (i.e., a power position of the rotor blade 30) and 90 degrees (i.e., a feathered position of the rotor blade 30).

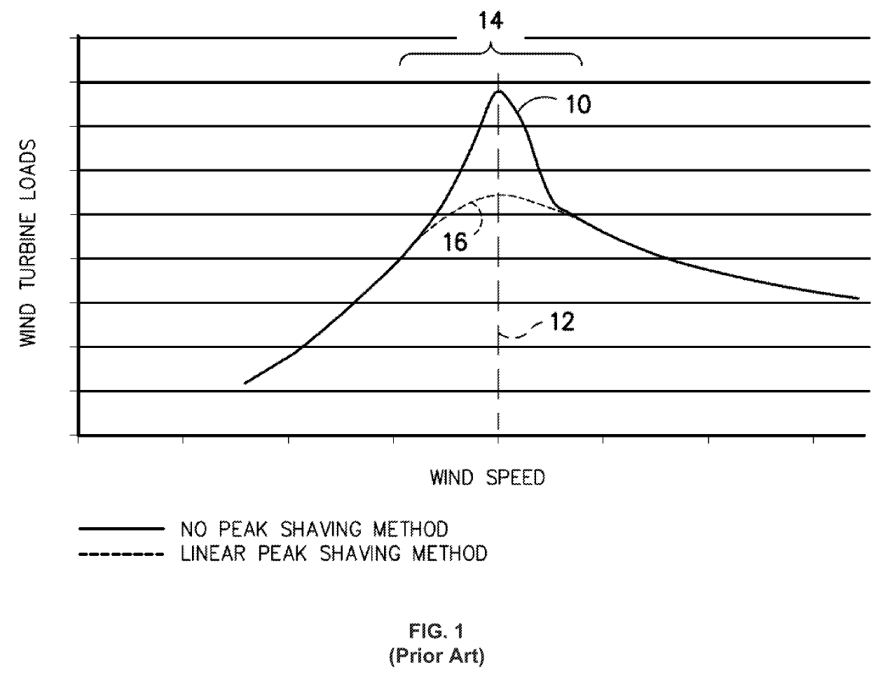

Referring now to FIG. 3, a simplified, internal view of one embodiment of the nacelle 26 of the wind turbine 20 shown in FIG. 1 is illustrated. As shown, a generator 34 may be disposed within the nacelle 26. In general, the generator 34 may be coupled to the rotor 28 for producing electrical power from the rotational energy generated by the rotor 28. For example, as shown in the illustrated embodiment, the rotor 28 may include a rotor shaft 44 coupled to the hub 30 for rotation therewith. The rotor shaft 44 may, in turn, be rotatably coupled to a generator shaft 46 of the generator 34 through a gearbox 48. As is generally understood, the rotor shaft 44 may provide a low speed, high torque input to the gearbox 48 in response to rotation of the rotor blades 32 and the hub 30. The gearbox 48 may then be configured to convert the low speed, high torque input to a high speed, low torque output to drive the generator shaft 46 and, thus, the generator 34.

Additionally, the turbine controller 36 may also be located within the nacelle 26. As is generally understood, the turbine controller 36 may be communicatively coupled to any number of the components of the wind turbine 20 in order to control the operation of such components. For example, as indicated above, the turbine controller 36 may be communicatively coupled to each pitch adjustment mechanism 42 of the wind turbine 20 (one of which is shown) via a pitch controller 40 to facilitate rotation of each rotor blade 32 about its pitch axis 38.

In general, each pitch adjustment mechanism 42 may include any suitable components and may have any suitable configuration that allows the pitch adjustment mechanism 42 to function as described herein. For example, in several embodiments, each pitch adjustment mechanism 42 may include a pitch drive motor 50 (e.g., any suitable electric motor), a pitch drive gearbox 52, and a pitch drive pinion 54. In such embodiments, the pitch drive motor 50 may be coupled to the pitch drive gearbox 52 so that the pitch drive motor 50 imparts mechanical force to the pitch drive gearbox 52. Similarly, the pitch drive gearbox 52 may be coupled to the pitch drive pinion 54 for rotation therewith. The pitch drive pinion 54 may, in turn, be in rotational engagement with a pitch bearing 56 coupled between the hub 30 and a corresponding rotor blade 32 such that rotation of the pitch drive pinion 54 causes rotation of the pitch bearing 56. Thus, in such embodiments, rotation of the pitch drive motor 50 drives the pitch drive gearbox 52 and the pitch drive pinion 54, thereby rotating the pitch bearing 56 and the rotor blade 32 about the pitch axis 38.

In alternative embodiments, it should be appreciated that each pitch adjustment mechanism 42 may have any other suitable configuration that facilitates rotation of a rotor blade 32 about its pitch axis 28. For instance, pitch adjustment mechanisms 42 are known that include a hydraulic or pneumatic driven device (e.g., a hydraulic or pneumatic cylinder) configured to transmit rotational energy to the pitch bearing 56, thereby causing the rotor blade 32 to rotate about its pitch axis 38. Thus, in several embodiments, instead of the electric pitch drive motor 50 described above, each pitch adjustment mechanism 42 may include a hydraulic or pneumatic driven device that utilizes fluid pressure to apply torque to the pitch bearing 56.

Referring still to FIG. 3, the wind turbine 20 may also include a plurality of sensors 58, 60 for monitoring one or more parameters and/or conditions of the wind turbine 20. As used herein, a parameter or condition of the wind turbine 20 is “monitored” when a sensor 58, 60 is used to determine its present value. Thus, the term “monitor” and variations thereof are used to indicate that the sensors 58, 60 need not provide a direct measurement of the parameter and/or condition being monitored. For example, the sensors 58, 60 may be used to generate signals relating to the parameter and/or condition being monitored, which can then be utilized by the turbine controller 36 or other suitable device to determine the actual parameter and/or condition.

In several embodiments of the present subject matter, the wind turbine 20 may include one or more sensors 58, 60 configured to monitor a peak shaving parameter of the wind turbine 20. As used herein, the term “peak shaving parameter” refers to any operating parameter and/or condition of a wind turbine 20 that may be directly or indirectly related to the pitch angle of a rotor blade such that the peak shaving control method described below with reference to FIG. 5 may be performed. For example, in several embodiments, the peak shaving parameter may correspond to the power output of the wind turbine 20. Thus, in such embodiments, the wind turbine 20 may include one or more power output sensors 58 configured to monitor the power output of the wind turbine 20. For instance, the power output sensor(s) 58 may comprise sensors configured to monitor electrical properties of the output of the generator 34, such as current sensors, voltage sensors or power monitors that monitor power output directly based on current and voltage measurements. Alternatively, the power output sensors 58 may comprise any other sensors that may be utilized to monitor the power output of a wind turbine 20. For example, in one embodiment, the power output sensors 58 may comprise one or more strain gauges or torque sensors configured to detect torque on the output shaft of the generator 34, which may then be correlated to the power output of the wind turbine 20.

In other embodiments, the peak shaving parameter may correspond to loads acting on the wind turbine 20. In such embodiments, the wind turbine 20 may include one or more load sensors 60 configured to monitor the loads acting on and/or through one or more of the components of the wind turbine 20. For example, the load sensors 60 may be configured to directly or indirectly measure thrust loads on one or more of the components of the wind turbine 20, such as by monitoring thrust loads on the rotor 28 by monitoring wind speed using an anemometer or any other suitable wind speed sensor. In addition, the load sensors 60 may be configured to directly or indirectly measure the moments acting on and/or through one or more of the components of the wind turbine 20 (e.g., by monitoring the bending moments acting on the tower and/or the blades and/or by monitoring the nodding moments acting on machine head), such as by using strain gauges, accelerometers, position sensors, optical sensors and/or the like to monitor the deflections of one or more wind turbine components caused by bending moments. For example, as shown in FIG. 3, one or more load sensors 60 may be mounted within the rotor blades 32 and/or the tower 14 to monitor any bending moments acting on such components. Of course, it should be appreciated that the load sensors 60 may comprise any other suitable sensors configured to monitor any other loads acting on the wind turbine 20.

It should also be appreciated that, in alternative embodiments, the peak shaving parameter may comprise any other suitable operating parameter and/or condition of a wind turbine 20 that may be directly or indirectly related to the target pitch angle required for peak shaving. In such embodiments, the wind turbine 20 may include any suitable sensors that permit such peak shaving parameter to be monitored. In addition, it should be appreciated that the peak shaving parameter may comprise a combination of operating parameters and/or conditions of a wind turbine 20, such as a combination of power output and loads.

In various aspects, deflection of the hub 30 caused by thrust on the one or more rotor blades 32 can be measured by various sensors located within the hub 30 including, for example, one or more laser deflection sensors, one or more distance measurement sensors, one or more strain gauges, and the like. Various combinations of such sensors can also be used in one aspect to measure hub deflection.

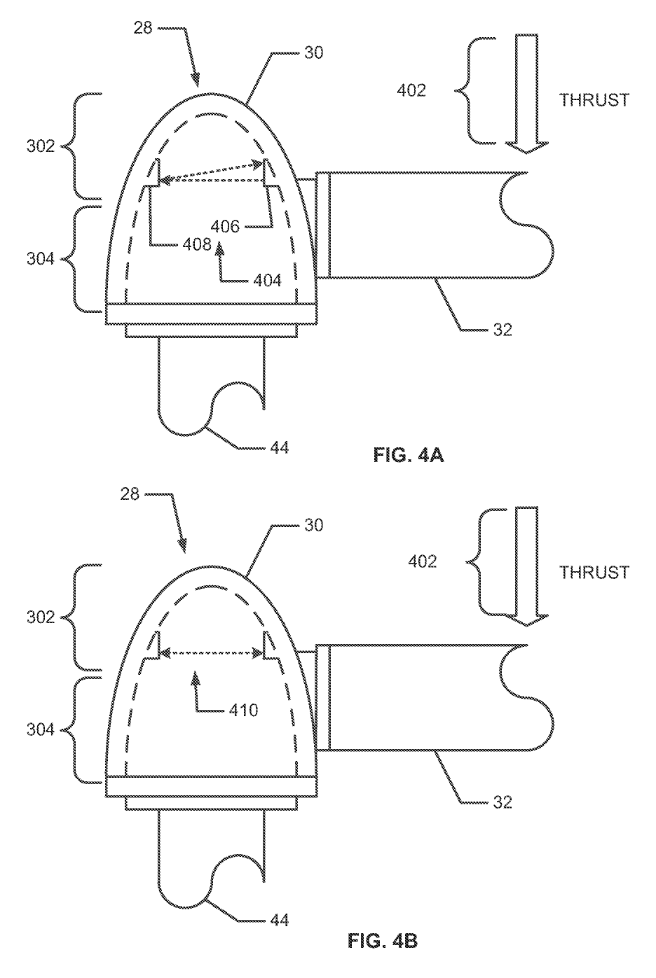

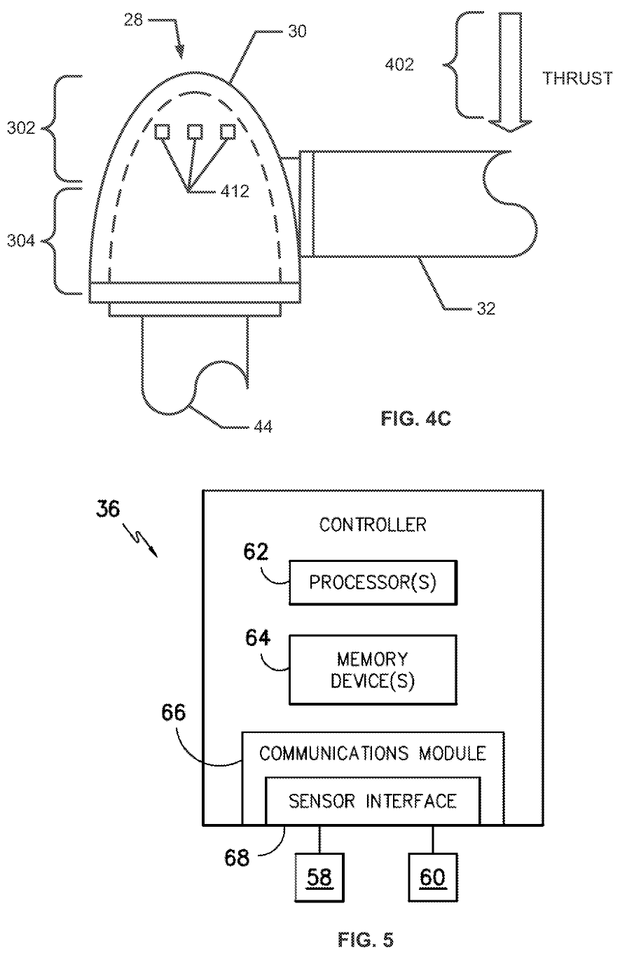

FIGS. 4A through 4C illustrate a portion of the rotor 28 of a wind turbine 20 having various sensors located within the hub 30 to measure deflection of the hub 30 caused by thrust 402 on the one or more rotor blades 32 of the wind turbine 20. Generally, thrust loads 402 bend the blades 32 toward the tower 22 of the wind turbine 20. This bending of the blades 32 also causes bending or deflection of the hub 30 to which the blades 32 are affixed. Generally, the front part 302 of the hub 30 is extended and the back part 304 of the hub 30, which is connected to the main shaft 44, is slightly compressed. Sensors can be positioned at various locations, both radially and axially, within the hub 30 to measure the deflection caused by the thrust 402. For example, FIG. 4A illustrates a portion of the rotor 28 of a wind turbine 20 having one or more laser deflection sensors 404 located within the hub 30 to measure deflection of the hub 30 caused by thrust 402 on the one or more rotor blades 32 of the wind turbine 20. One or more of the laser deflection sensors 404 can be located at various locations in the hub 30 to measure deflection of the hub 30. Generally, the laser deflection sensor 404 is comprised of a laser source and receiver 406 and a mirror 408. Deflection of the hub caused by thrust on the one or more rotor blades 32 of the wind turbine 20 causes the location of the reflected laser on the receiver to change. This change can cause the laser deflection sensor 404 to transmit a signal that correlates with the changed location. For example, this signal may be transmitted to the turbine controller 36 where the signal can be correlated with the amount of thrust on the wind turbine 20. This signal can be transmitted to the turbine controller 36 via wired (including fiber optic) or wireless communications medium, or combinations thereof.

FIG. 4B illustrates a portion of the rotor 28 of a wind turbine 20 having one or more distance measurement sensors 410 located within the hub 30 to measure deflection of the hub 30 caused by thrust 402 on the one or more rotor blades 32 of the wind turbine 20. One or more of the distance measurement sensors 410 can be located at various locations, both radially and axially, in the hub 30 to measure deflection of the hub 30. For example, the one or more distance measurement sensors 410 can comprise one or more optical (including laser and photoelectric), mechanical, inductive, ultrasonic, and the like distance measurement devices. Generally, deflection of the hub caused by thrust on the one or more rotor blades 32 of the wind turbine 20 causes the distances within the hub 30 to change, which can be detected by the one or more distance measurement sensors 410 and converted into a signal that correlates with the changed distances. This signal may be transmitted to the turbine controller 36 where the signal can be correlated with the amount of thrust on the wind turbine 20. This signal can be transmitted to the turbine controller 36 via wired (including fiber optic) or wireless communications medium, or combinations thereof.

FIG. 4C illustrates a portion of the rotor 28 of a wind turbine 20 having one or more strain gauges 412 located within the hub 30 to measure deflection of the hub 30 caused by thrust 402 on the one or more rotor blades 32 of the wind turbine 20. One or more of the strain gauges 412 can be located at various locations, both radially and axially, in the hub 30 to measure deflection of the hub 30. Generally, deflection of the hub caused by thrust on the one or more rotor blades 32 of the wind turbine 20 causes the distances within the hub 30 to change, which can be detected by the one or more strain gauges 412 and converted into a signal that correlates with the changed distances. This signal may be transmitted to the turbine controller 36 where the signal can be correlated with the amount of thrust on the wind turbine 20. This signal can be transmitted to the turbine controller 36 via wired (including fiber optic) or wireless communications medium, or combinations thereof.

FIGS. 4A-4C illustrate non-limiting examples of sensors that can be used to detect deflection of the hub 30 cause by thrust 402. It is to be appreciated that any other sensor, transducer or measurement device, now existing or later developed, that can detect or measure deflection of the hub 30 is contemplated within the scope of embodiments of the present invention.

Referring now to FIG. 5, there is illustrated a block diagram of one embodiment of suitable components that may be included within the turbine controller 36 (or the pitch controller 40), or any other controller that receives a signal from the sensors located within the hub 30, in accordance with aspects of the present subject matter. As shown, the turbine controller 36 may include one or more processor(s) 62 and associated memory device(s) 64 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 64 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 64 may generally be configured to store suitable computer-readable instructions that, when implemented by the processor(s) 62, configure the turbine controller 36 to perform various functions including, but not limited to, directly or indirectly (via the pitch controller 40) transmitting suitable control signals to one or more of the pitch adjustment mechanisms 42, monitoring the peak shaving parameter(s) of the wind turbine 20, determining target pitch angles for the rotor blades 32 based on the peak shaving parameter(s) and various other suitable computer-implemented functions.

Additionally, the turbine controller 36 may also include a communications module 66 to facilitate communications between the controller 36 and the various components of the wind turbine 10. For instance, the communications module 66 may serve as an interface to permit the turbine controller 36 to transmit control signals to each pitch adjustment mechanism 42 for controlling the pitch angle of the rotor blades 32. Moreover, the communications module 66 may include a sensor interface 68 (e.g., one or more analog-to-digital converters) to permit signals transmitted from the sensors (e.g., 58, 60, 404, 410, 412) to be converted into signals that can be understood and processed by the processors 62. The turbine controller 36 may be communicatively coupled to one or more sensors 58, 50m 404, 410, 412 configured to monitor a peak shaving parameter of the wind turbine 20, such as the power output of the wind turbine 20, and/or the loads acting on the wind turbine 20 including deflection of the hub 30 caused by thrust loading 402 on at least one of the one or more rotor blades of the wind turbine 20. Thus, the turbine controller 36 may be configured to receive signals from such sensors 58, 60, 404, 410, 412 associated with the peak shaving parameter. Alternatively, the turbine controller 36 may be provided with suitable computer readable instructions that, when implemented by its processor(s) 62, configure the turbine controller 36 to calculate and/or estimate one or more of the peak shaving parameters of the wind turbine 20 based on information stored within its memory 64 and/or based on other inputs received by the turbine controller 36.

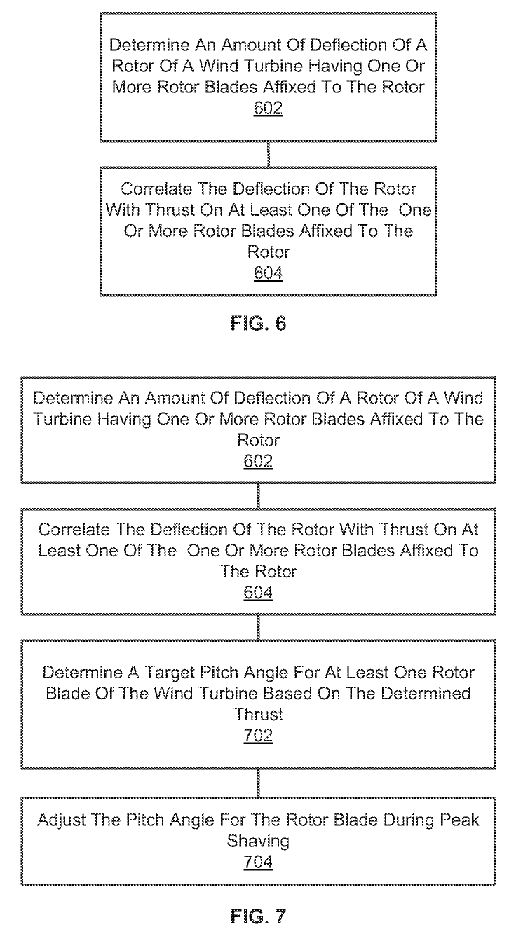

Referring now to FIG. 6, there is illustrated one embodiment of a method for determining the thrust on a wind turbine having one or more rotor blades affixed to a hub of the wind turbine by measuring deflection of the hub caused by the thrust. As shown, the method generally includes step 602, receiving a signal with a controller, wherein the signal indicates the amount of deflection of the hub. As described herein, such deflection can be detected by one or more various sensors located within the hub including, for example, one or more laser deflection sensors, one or more distance measurement sensors, one or more strain gauges, and the like. The various sensors can convert the detected deflection to a signal that can be transmitted to the controller. At step 604, the detected deflection can be correlated with thrust on at least one of the one or more rotor blades of the wind turbine. Such correlation can be performed by the controller using tables, graphs, and the like for various designs, configurations and materials used to construct the wind turbine. FIG. 7 illustrates the steps of the method of FIG. 6, further including the step (step 702) of determining a target pitch angle for at least one rotor blade of the wind turbine based on the determined thrust and (step 704) adjusting the pitch angle for the rotor blade during peak shaving.

By providing the ability to more quickly adjust the loads acting on a wind turbine 20, the power output that may be achieved using the disclosed methods can be higher than the power output that may achieved using conventional peak shaving methods where thrust is an estimated or calculated value rather than a directly measured value. For example, in some embodiments, an increase in annual energy production (AEP) of about 1 to 2% may be obtained using the disclosed methods for peak shaving as opposed to the conventional peak shaving methods. However, it is also believed that increases in AEP of greater than about 1 to 2% may also be achieved using the disclosed methods.

As indicated above, it should be appreciated that, in several embodiments, the disclosed methods may be implemented automatically using the turbine controller 36 or any other suitable processing unit. For example, the rotor blades 32 may be maintained in the power position until the predetermined peak shaving threshold is reached. However, once the predetermined peak shaving threshold is reached, the turbine controller 36 may automatically adjust the pitch angle of the rotor blades 32, such as by directly or indirectly (via the pitch controller(s) 40) transmitting control signals to the pitch adjustment mechanisms 42, based on the peak shaving parameter(s) of the wind turbine 20. For instance, as described above, in one embodiment, data correlating hub deflection with thrust may be stored within the memory of the controller 36. In such an embodiment, the controller 36 may be configured to automatically determine the peak shaving parameter (e.g., by analyzing measurement signals from the sensors 58, 60, 408. 410, 412 described above) and then calculate the target pitch angle for each rotor blade 32 based on the measured thrust. The calculated pitch angles may then be used as the basis for adjusting the actual pitch angles of the rotor blades during peak shaving.

As described above and as will be appreciated by one skilled in the art, embodiments of the present invention may be configured as a system, method, or computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as the processor(s) 62 discussed above with reference to FIG. 5, to produce a machine, such that the instructions which execute on the computer or other programmable data processing apparatus create a means for implementing the functions specified in the flowchart block or blocks.

These computer program instructions may also be stored in a non-transitory computer-readable memory that can direct a computer or other programmable data processing apparatus (e.g., processor(s) 62 of FIG. 5) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprised of:
a wind turbine comprising a rotor, wherein one or more rotor blades of the wind turbine are affixed to the rotor; and
one or more sensors located on or within the rotor, wherein the one or more sensors measure deflection of the rotor.

2. The system of claim 1, wherein the one or more sensors measure deflection of the rotor caused by thrust on the one or more rotor blades of the wind turbine.

3. The system of claim 1, further comprising a controller, wherein the one or more sensors provide a signal, said signal indicating an amount of deflection of the rotor caused by thrust on the one or more rotor blades of the wind turbine, said signal provided to the controller and the controller determines a value for the thrust on at least one of the one or more rotor blades of the wind turbine using said signal.

4. The system of claim 3, wherein the value for the thrust on the one or more rotor blades of the wind turbine is used by the controller to determine at least in part a pitch angle for at least one of the one or more rotor blades during peak shaving.

5. The system of claim 1, wherein the one or more sensors comprise one or more laser deflection sensors, one or more distance measurement sensors, one or more strain gauges, or combinations thereof.

6. The system of claim 5, wherein the one or more distance measurement sensors comprise one or more optical (include laser and photoelectric), mechanical, inductive and ultrasonic distance measurement devices.

7. The system of claim 1, wherein the one or more sensors located on or within the rotor are located within the hub of the rotor.

8. A system comprised of:
a wind turbine comprising a hub, wherein one or more rotor blades of the wind turbine are affixed to the hub;
one or more sensors located within the hub, wherein the one or more sensors measure deflection of the hub; and
a controller, wherein the controller is configured to:
receive a signal from said one or more sensors, said signal indicating an amount of deflection of the hub caused by thrust on the one or more rotor blades of the wind turbine;
determine a value for the thrust on the one or more rotor blades of the wind turbine using said signal; and
determine, using at least in part the value for the thrust on the one or more rotor blades of the wind turbine, a pitch angle for at least one of the one or more rotor blades during peak shaving.

9. The system of claim 8, wherein the one or more sensors comprise one or more laser deflection sensors, one or more distance measurement sensors, one or more strain gauges, or combinations thereof.

10. The system of claim 9, wherein the one or more distance measurement sensors comprise one or more optical (include laser and photoelectric), mechanical, inductive and ultrasonic distance measurement devices.

11. The system of claim 8, wherein the controller is further configured to transmit a control signal to adjust the pitch angle for at least one of the one or more rotor blades during peak shaving in accordance with the determined pitch angle.

12. The system of claim 11, wherein the control signal is transmitted to an actuator.

13. The system of claim 12, wherein the actuator comprises one or more of an electric motor, a hydraulic actuator, a pneumatic actuator or combinations thereof.

14. A method comprising:
determining an amount of deflection of a rotor of a wind turbine having one or more rotor blades affixed to the rotor;
correlating the amount of deflection of the rotor with thrust on at least one of the one or more rotor blades; and
adjusting a pitch angle for at least one of the one or more rotor blades during peak shaving.

15. The method of claim 14, wherein determining the amount of deflection of the rotor of the wind turbine having one or more rotor blades affixed to the rotor comprises using one or more sensors located on or within the rotor to measure the deflection.

16. The method of claim 15, wherein the one or more sensors measure deflection of the rotor caused by thrust on the one or more rotor blades of the wind turbine.

17. The method of claim 16, wherein the one or more sensors provide a signal indicating an amount of deflection of the rotor caused by thrust on the one or more rotor blades of the wind turbine to a controller and the controller correlates the amount of deflection of the rotor with thrust on at least one of the one or more rotor blades and determines a value for the thrust on at least one of the one or more rotor blades of the wind turbine using said signal.

18. The method of claim 17, wherein the value for the thrust on the one or more rotor blades of the wind turbine is used by the controller to determine at least in part the pitch angle for at least one of the one or more rotor blades during peak shaving.

19. The method of claim 15, wherein the one or more sensors comprise one or more laser deflection sensors, one or more distance measurement sensors, one or more strain gauges, or combinations thereof.

20. The method of claim 19, wherein the one or more distance measurement sensors comprise one or more optical (include laser and photoelectric), mechanical, inductive and ultrasonic distance measurement devices.
